(19) United States
(12) Patent Application Publication
(10) Pub. No.: US 2012/0073152 A1
(43) Pub. Date: Mar. 29, 2012

(54) Universal tape and drywall scoring apparatus

(76) Inventor: Brad McGahan, Simi Valley, CA (US)

(21) Appl. No.: 13/199,978

(22) Filed: Sep. 13, 2011

Related U.S. Application Data
(63) Continuation-in-part of application No. 12/799,892, filed on May 3, 2010, now Pat. No. 8,020,312.

(51) Int. Cl. G01B 3/10; B43L 13/00

(52) U.S. Cl. 33/32.3; 33/760

(57) ABSTRACT

A universal tape and drywall scoring apparatus for use with a tape measure that includes a tape measure encasement for encasing a portion of the tape measure housing, a clip assembly connected to the distal end of the measuring tape, the clip assembly comprising a hollow housing having a top wall provided with a slot and a pair of spaced apart side walls each having a cavity formed therein, and a cutting assembly connected to the clip assembly, the cutting assembly comprising a scoring blade receivable within the slot in the top wall of the hollow housing of the clip assembly and a pair of spaced apart connector clips having end portions receivable the cavities formed in the side walls of the clip assembly.

### CROSS-REFERENCE TO RELATED APPLICATIONS

This application is a Continuation-in-Part of U.S. Application No. 12,799,892 filed on May 3, 2010.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to measuring, marking and cutting tools of the character used in the construction industry. More particularly, the invention concerns an apparatus for use in combination with a tape measure having a housing and a self-recoiling measuring tape extendible from the housing for measuring, marking and scoring dry wall.

2. Description of Related Art Including Information Disclosed Under 37 CFR 1.97 and 1.98

In the construction industry, there is a recurring need for measuring, marking, and cutting tools for use in connection with planar materials such as drywall. In practice, there are individual tools, such as large drywall squares, that are available which accomplish the various tasks required to mark, cut and finish a sheet of material. The problem lies in the fact that the requirement to use various individual tools is cumbersome and time consuming by the user to finish the particular task at hand.

U.S. Pat. No. 6,763,603 issued to Carrabino concerns a tape scriber formed as an integral device, either molded or cast, that includes a base portion, having a cavity formed therein, for accommodating the tab end of the tape. The base portion includes a laterally extending stem, having a slot there through, and into which a box cutter may locate its razor tip, in preparation for cutting of a board during usage. A rearwardly extending member includes an inclined slot, or at least a slot which accommodates a pencil upon an incline with the tip of the pencil extending through a bottom aperture, aligning under the precise end of the tape, to furnish a scribe or pencil mark at that location, as the rule is moved, to the exact dimension measured on its tape during usage.

U.S. Pat. No. 6,931,734 issued to Elder et al. discloses an implement alignment and guide system that comprises a tool which is adapted to be used in conjunction with a measuring tape to enable a worker to make accurate alignment marks while engaging in the art of carpentry, drywall, insulation and so forth.

The U.S. patent to Kim, U.S. Pat. No. 6,694,622, discloses a combination measuring, marking and cutting tool that comprises a housing, a measuring tape extendable from the housing, a ferrule attached to the free end of the measuring tape, an aperture formed in the ferrule, and a T-shaped pivot tab secured to the housing in proximity to the measuring tape.

### BRIEF SUMMARY OF THE INVENTION

By way of brief summary, the present invention concerns the use in combination with a tape measure having a housing and an elongate tape extendible from the housing, the tape measure having a tab end, a universal tape and drywall scoring apparatus that includes a tape measure encasement for encasing a portion of the tape measure housing, a clip assembly connected to the distal end of the measuring tape, the clip assembly comprising a hollow housing having a top wall provided with a slot and a pair of spaced apart side walls each having a cavity formed therein, and a cutting assembly connected to the clip assembly, the cutting assembly comprising a scoring blade receivable within the slot in the top wall of the hollow housing of the clip assembly and a pair of spaced apart connector clips having end portions receivable within the cavities formed in the side walls of the clip assembly.

With the foregoing in mind, it is an object of the invention to provide a universal tape and drywall scoring apparatus in which, during use, the tape measure housing of the tape is securely contained within a compact, easy to grip tape measure encasement.

Another object of the invention is to provide a universal tape and drywall scoring apparatus of the character described in the preceding paragraphs in which, during use, the tab end of the tape measure can be positively secured within a cutting assembly with which a conventional type of box cutter can be quickly and easily interconnected and disconnected.

Another object of the invention is to provide a universal tape and drywall scoring apparatus of the type described in the preceding paragraph in which the clip assembly of the device can be positively interconnected with the measuring tape of the tape measure.

Another object of the invention is to provide a universal tape and drywall scoring apparatus of the character described in the preceding paragraphs that can be used with equal efficiency by left-handed and right-handed workmen. More particularly, it is an object of the invention to provide a universal tape and drywall scoring apparatus in which the cutting assembly of the apparatus can be connected to said clip assembly of the apparatus in a first position for use by a right-handed workman to score the panel in a first direction and can be connected to said clip assembly in a second position for use by a left-handed workman scoring the panel in a second direction.

The foregoing as well as other objects of the invention will be achieved by the novel apparatus of the invention illustrated in the accompanying drawings and described in the specification that follows.

### BRIEF DESCRIPTION OF SEVERAL VIEWS OF THE DRAWINGS

FIG. 1 is a generally perspective, diagrammatic view of one form of the universal tape and drywall scoring apparatus of the invention, showing in solid lines the arrangement of the scoring assembly of the device for use by a right-handed workman and showing in phantom lines the arrangement of the scoring assembly of the device for use by a left-handed workman.

FIG. 2 is a generally perspective, exploded view of the clip assembly of the invention that can be interconnected with the distal end of the tape of a conventional tape measure and the cutting assembly that is releasably connected to the clip assembly.

FIG. 3 is a generally perspective view of the clip assembly of the invention.

FIG. 3A is a generally perspective, fragmentary view of the torsion pin component of the tape securement sub-assembly of the clip assembly that functions to releasably secure the hollow housing of the clip assembly to the measuring tape of the tape measure.

FIG. 4 is a front elevational view of the assemblage shown in FIG. 2 in an assembled configuration.

FIG. 5 is an enlarged view taken along lines 5-5 of FIG. 4.

FIG. 6 is an enlarged cross-sectional view taken along lines 6-6 of FIG. 4.

FIG. 7 is a cross-sectional view taken along lines 7-7 of FIG. 6.

FIG. 8 is a cross-sectional view similar to FIG. 6, but showing the scoring blade receiving assembly disconnected from the clip assembly.

FIG. 9 is a generally perspective exploded view similar to FIG. 6, but showing the left-hand configuration of the scoring assembly of the invention

FIG. 10 is a generally perspective, exploded view of the tape measure encasement component of the apparatus of the invention.

FIG. 11 is a front view of the tape measure encasement component showing the housing of the tape measure in position within the tape measure encasement component.

FIG. 12 is a greatly enlarged cross-sectional view taken along lines 12-12 of FIG. 14.

FIG. 13 is a view taken along lines 13-13 of FIG. 12.

FIG. 14 is a side elevational view illustrating the housing of the tape measure in position within the tape measure encasement component, showing the tape of the tape measure extended and showing in phantom lines the clip assembly in position over the distal end of the tape measure.

FIG. 15 is a top plan view illustrating the housing of the tape measure in position within the tape measure case component and showing the tape of the tape measure partially extended.

FIG. 16 is a generally perspective, exploded view of an alternate form of the universal tape and drywall scoring apparatus of the invention.

FIG. 16A is an enlarged view taken along lines 16A-16A of FIG. 16.

FIG. 17 is a generally perspective view similar to FIG. 16 showing the cutting assembly of the invention interconnected with the distal end of the tape of a conventional tape measure.

FIG. 18 is a generally perspective, diagrammatic view of the alternate form of the universal tape and drywall scoring apparatus of the invention as arranged for use by a right-handed workman.

FIG. 19 is a generally perspective, diagrammatic view of the alternate form of the universal tape and drywall scoring apparatus of the invention as arranged for use by a left-handed workman.

FIG. 20 is a generally perspective view of still another form of the universal tape and drywall scoring apparatus of the invention.

FIG. 21 is an enlarged, exploded cross-sectional view of an adapter assembly for mounting a selected implement within the hollow housing of the operating assembly shown in FIG. 20.

FIG. 22 is a generally perspective, exploded view of the operating assembly and a portion of the tape measure shown in FIG. 20.

FIG. 23 is a cross-sectional view taken along lines 23-23 of FIG. 22 showing a writing implement disposed within an adapter assembly which is, in turn, disposed within the hollow housing of the operating assembly shown in FIG. 20 and showing the securement assembly in the second gripping position gripping the adapter assembly.

FIG. 24 is a generally perspective, exploded view of the tape measure encasement assembly of the alternate form of universal tape and drywall scoring apparatus shown in FIG. 20.

FIG. 25 is a generally perspective view similar to FIG. 24, but showing the tape measure encasement assembly of the alternate form of universal tape and drywall scoring apparatus shown in FIG. 20 in an assembled configuration.

FIG. 25A is a cross-sectional view taken along lines 25A-25A of FIG. 25 illustrating the manner of retracting the pivot pin of the device.

FIG. 26 is a side elevational, exploded view similar to FIG. 24 further illustrating the configuration of the tape measure encasement assembly of the alternate form of universal tape and drywall scoring apparatus shown in FIG. 20.

FIG. 27 is a side elevational, exploded view similar to FIG. 25, but showing only the tape measure encasement component of the alternate form of universal tape and drywall scoring apparatus and showing the pivot member of the device in a retracted position.

FIG. 28 is a generally diagrammatic view showing the tape measure encasement component of the alternate form of universal tape and drywall scoring apparatus being used to produce generally arcuate score marks on the work piece.

### DETAILED DESCRIPTION OF THE INVENTION

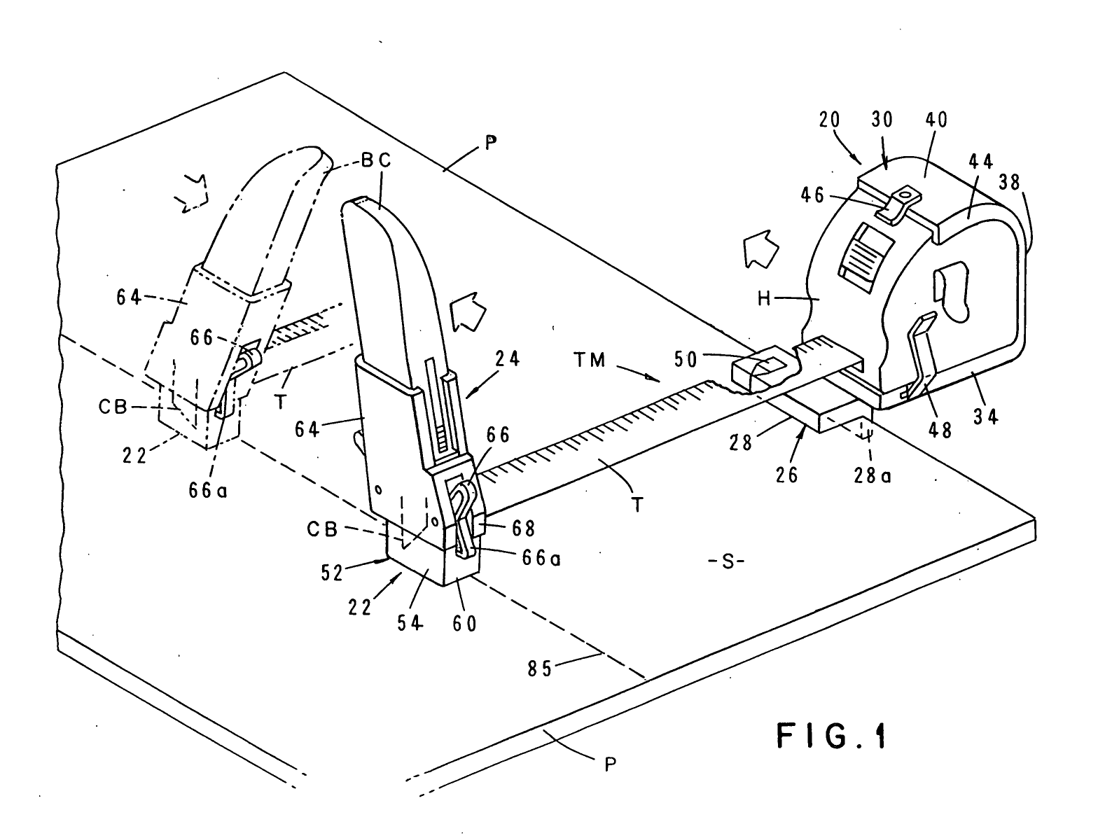

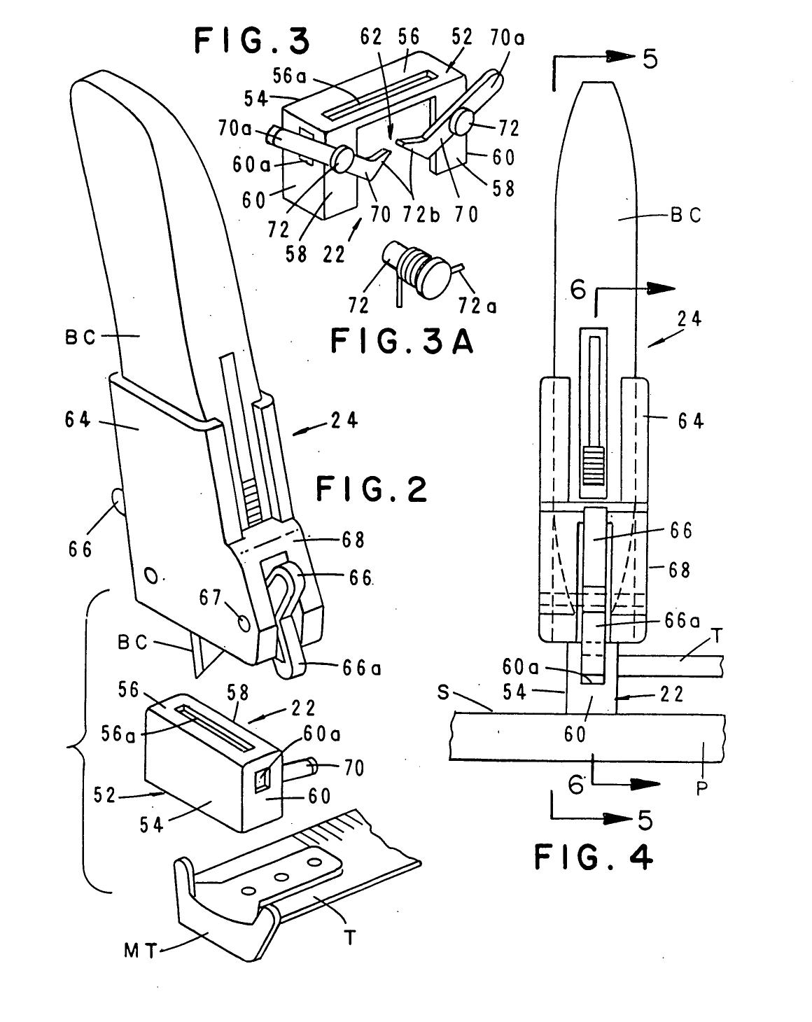

Referring to the drawings and particularly to FIG. 1, one form of the apparatus of the invention for measuring, marking and cutting a panel “P”, such as a sheet of drywall having an upper surface “S”, is there shown. The apparatus of the invention is used in combination with a conventional tape measure “TM” having a housing “H” and a self-recoiling measuring tape “T” extendible from the housing. The elongate measuring tape, which has a slight upward transverse curvature, typically retractably unrolls from a slot in the housing. At its distal end, the tape is provided with a short metal tab “MT” (FIG. 2) that serves the dual function of preventing the free end of the steel tape from entering the housing of the tape measure through the slot in the housing when retracted and providing the user of the tape measure with a means of conveniently grasping the free end of the tape when manipulating the tape.

The apparatus of the present form of the invention comprises three major components, namely a tape measure encasement assembly 20 for encasing a portion of the tape measure housing “H”, a clip assembly 22 adapted to be releasably connected to the distal end of the measuring tape and a cutting assembly 24 that is adapted to be releasably connected to the clip assembly.

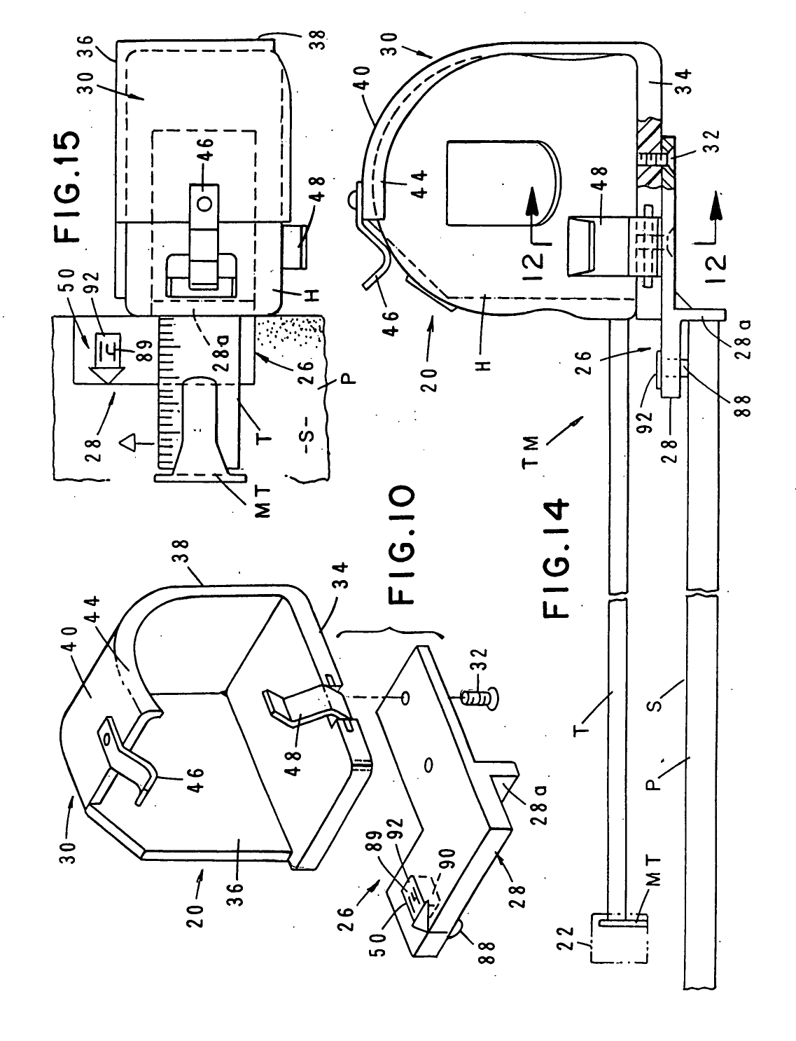

Considering first the novel tape measure encasement assembly 20, as best seen in FIGS. 1 and 10 of the drawings, this novel assembly includes a base assembly 26 comprising a platform assembly 28 having a downwardly extending guide segment 28a and an encasement assembly 30 that is connected to platform assembly 28 by conventional fasteners 32 (FIG. 10). As best seen in FIG. 10, encasement assembly 30 includes a base wall 34, a sidewall 36 connected to base wall 34 and an end wall 38 that is also connected to base wall 34. End wall 38 includes a top wall portion 40 and a downwardly extending flange portion 44. A yieldably deformable retaining clip 46 is connected to top wall portions 40 and is constructed and arranged to engage the housing of the tape measure when the housing is in position within the encasement assembly 30 in the manner shown in FIG. 1 of the drawings. Also forming a part of the encasement assembly 30 is a retainer 48 that is pivotally connected to base wall 34 for movement between a first position shown by the solid lines in FIG. 11 where the extremity of the retainer is in engagement with the housing of the tape measure and a second lowered position shown by the phantom lines in FIG. 11.

Forming a part of the platform assembly 28 of the encasement assembly is the important roller wheel assembly 50 of the invention for measuring the travel of the tape measure encasement relative to the panel “P”. The details of construction and operation of this important lower wheel assembly will be discussed in the paragraphs that follow.

Referring particularly to FIGS. 1, 2 and 3 of the drawings, the previously identified clip assembly 22 of the invention, which is releasably connected to the distal end of the measuring tape, can be seen to comprise a hollow housing 52 having a front wall 54, a top wall 56 connected to the front wall, a rear wall 58 connected to the top wall and a pair of spaced apart side walls 60 that are also connected to the top wall in the manner shown in the drawings. For a purpose presently to be described, top wall 56 is provided with a slot 56a and each of the side walls 60 is provided with a cavity 60a.

As best seen in FIG. 3 of the drawings, a novel tape securement clip assembly 62 is connected to the rear wall 58 of the housing 52 for releasably securing the hollow housing to the measuring tape “T” of the tape measure. The construction and operation of the securement clip assembly will presently be described.

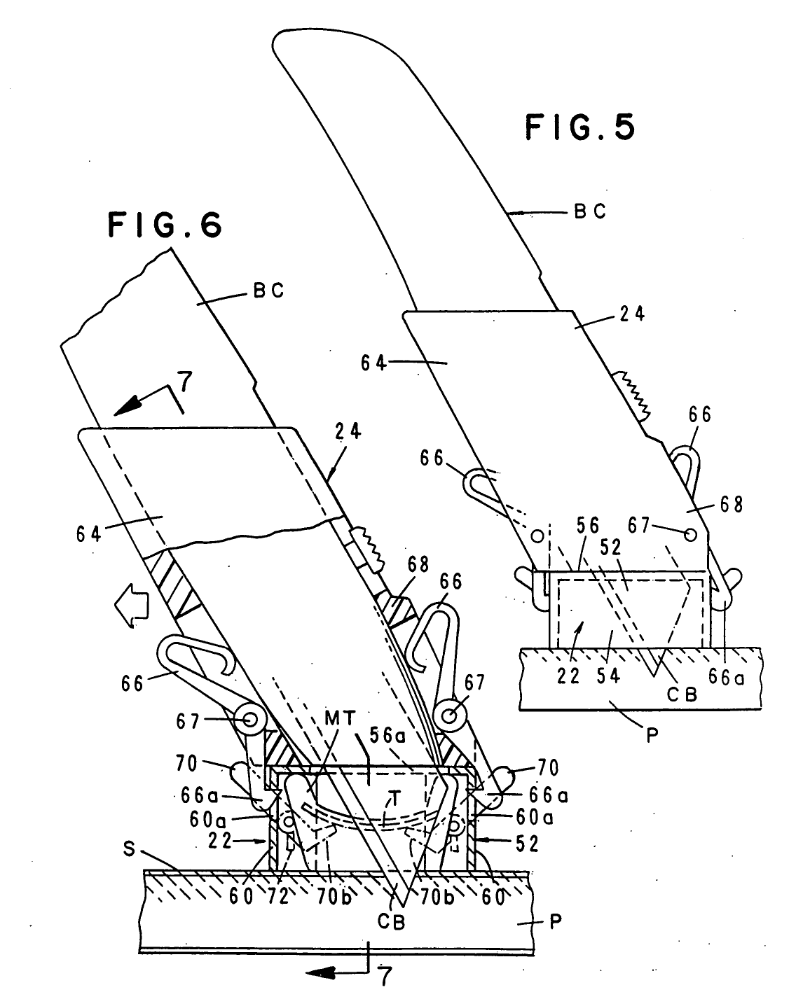

Releasably connected to the clip assembly 22 is the previously identified cutting assembly 24 that here comprises a sheath structure 64 that is uniquely designed to carry a cutting instrument such as a conventional, readily commercially available box cutter “BC” (FIG. 2). When the cutting instrument is seated within the sheath structure 64 in the manner illustrated in FIG. 2, the cutting blade “CB” of the cutting instrument extends downwardly from the bottom wall of the sheath structure. When the sheath assembly 24 is mated with the clip assembly 22 in the manner illustrated in FIGS. 5 and 6 of the drawings, the cutting blade is received within the slot 56a formed in the clip assembly housing 52 and extends downwardly into cutting engagement with the panel “P”.

Sheath assembly 24 includes a pair of spaced apart connector members 66 that are pivotally connected to the housing 68 of the sheath assembly in the manner illustrated in FIGS. 6 and 8 of the drawings. Each of the connector members 66 has an end portion 66a and each is movable about a pivot pin 67 from a first retracted position shown in FIG. 8 of the drawings into a second gripping position shown in FIG. 6 of the drawings. When the connector members are in the second gripping position, the end portions 66a thereof are receivable within the cavities 60a formed in said side walls of said clip assembly.

In using the apparatus of the invention, the retainer member 48 of the tape measure encasement assembly 20 is first moved into its lowered position and the housing “H” of the tape measure is positioned within the encasement assembly 30. This done, the retainer member is moved into its upper position so as to securely lock the housing of the tape in position within the encasement assembly 30.

Next, the clip assembly 22 is interconnected with the distal end of the tape in the manner illustrated in FIG. 8 of the drawings. This step is accomplished by gripping the upper extremities 70a of the locking arms 70 of the tape securement clip assembly 62 and moving them inwardly against the urging of the torsion pin assemblies 72 which interconnect the locking with the rear wall of the clip assembly (see FIG. 3). This inward movement of the upper extremities of the locking arms 70 causes the lower tape engaging extremities 70b of the locking arms to separate, permitting the tape “T” to pass between the extremities 70b. Upon the release of the upper extremities of the locking arms, the torsion springs 72a of the torsion pin assemblies 72 (see FIG. 3A) will urge the lower tape engaging extremities 70b of the locking arms into engagement with the lower surface of the tape (see FIG. 6).

With the clip assembly 22 connected to the distal end of the tape, the downwardly extending guide segment 28a of the platform assembly 28 can be positioned against the edge of the panel to be cut in the manner illustrated in FIG. 1 of the drawings. Next, the tape “T” can be withdrawn from the housing “H” to a distance corresponding to the location at which the panel is to be scored (for example, see the dotted line 85 in FIG. 1). With the clip assembly in the correct position, the cutting assembly 24 can be mated with the clip assembly in the manner previously described. If the workman is right-handed, the cutting assembly will be mated with the clip assembly in the manner shown by the solid lines in FIG. 1. Conversely, if the workman is left-handed, the cutting assembly will be mated with the clip assembly in the manner shown by the phantom lines in FIG. 1.

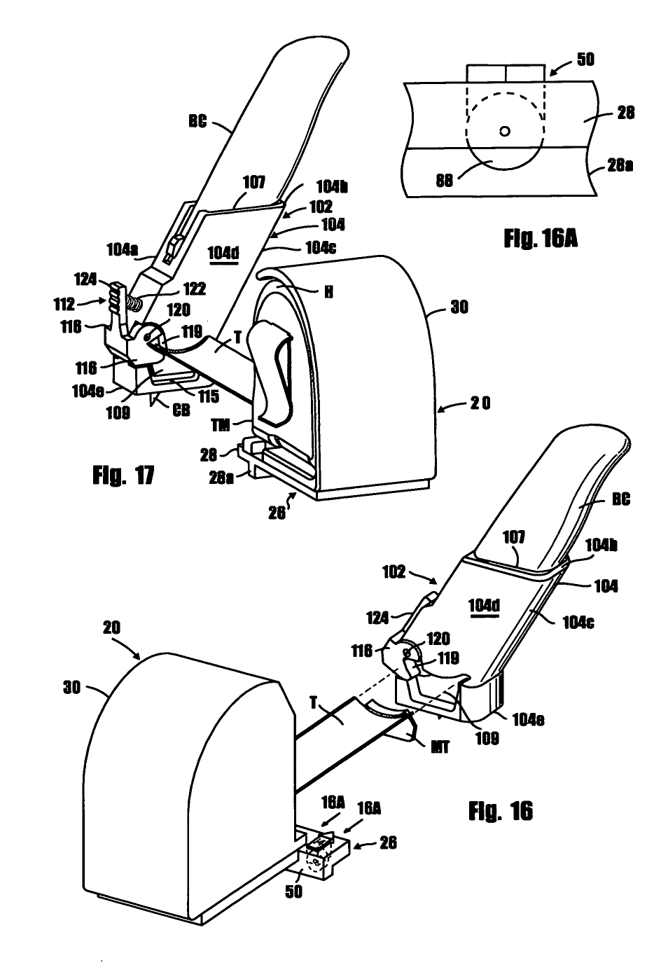

With the apparatus in the position illustrated in FIG. 1 of the drawings, the scoring operation can be commenced by simultaneously moving the tape measure encasement assembly 20 and a cutting assembly 24 longitudinally of the panel. As the tape measure encasement assembly 20 moves longitudinally of the panel, the previously identified roller wheel assembly 50 of the invention will measure the travel of the tape measure encasement relative to the panel. The roller wheel assembly 50, which is of a conventional construction, comprises roller 88 that is rotatably carried by platform 26. Roller 88 is mechanically coupled with a counter 90 that is also carried by platform 26 and includes indicia 89 that is visible through a window 92 provided in the platform (See FIGS. 10-15).

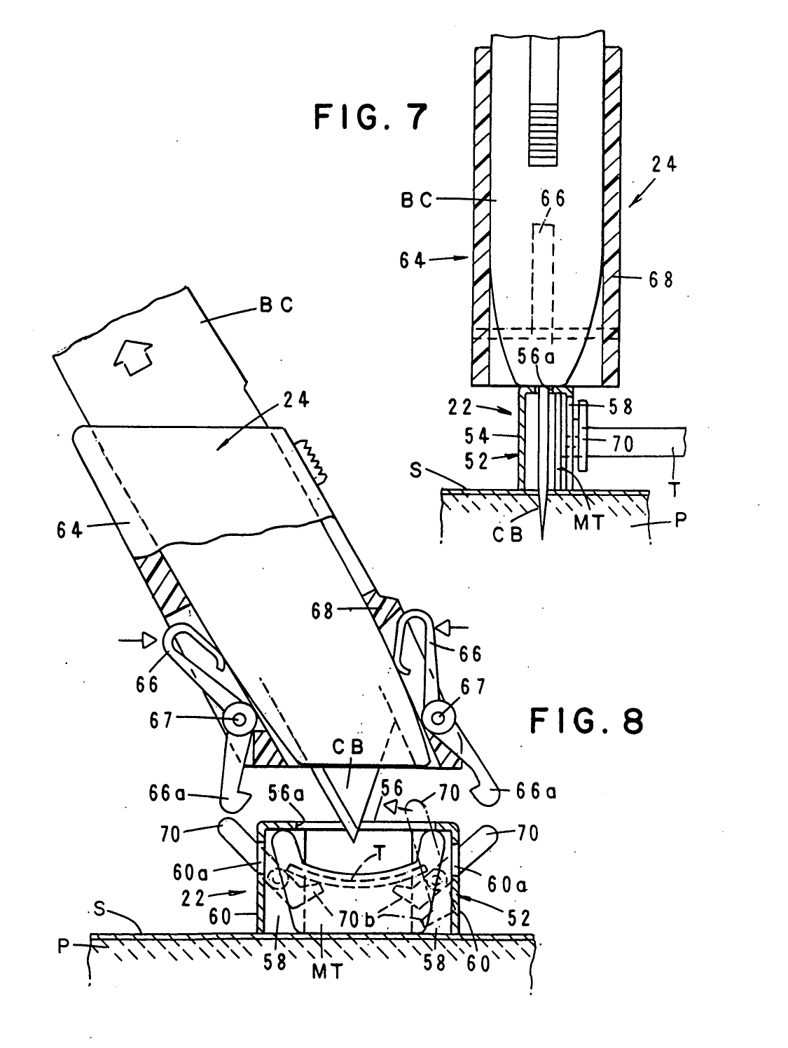

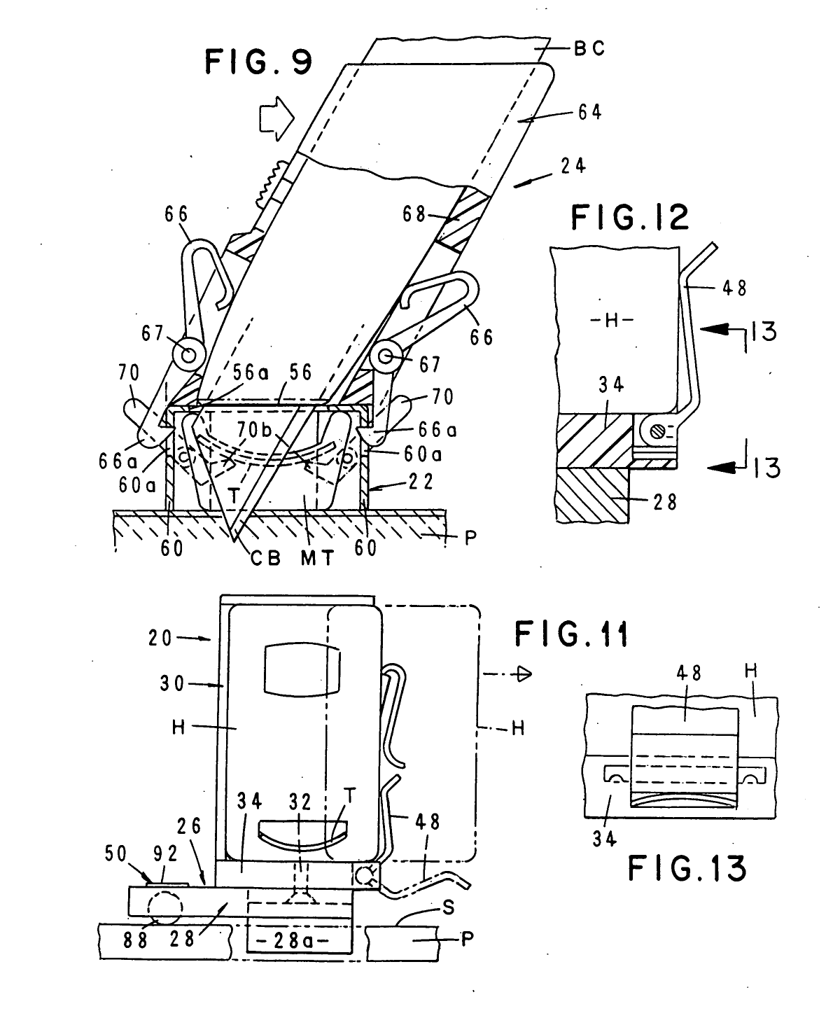

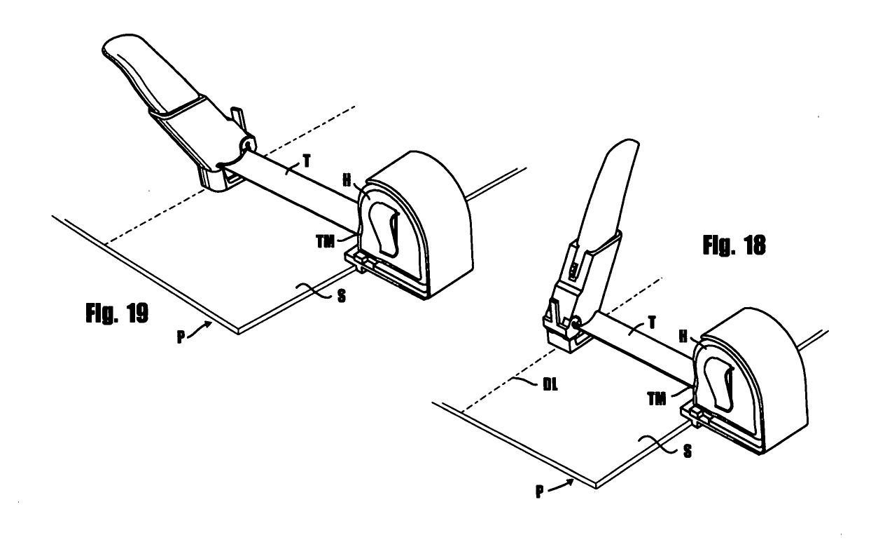

Turning now to FIGS. 16 through 19, an alternate form of the apparatus of the invention for measuring, marking and cutting a panel “P”, such as a sheet of drywall having an upper surface “S”, is there shown (see FIGS. 18 and 19). This latest form of the apparatus of the invention is similar in many respects to the embodiment of FIGS. 1 through 15 and like numerals are used in FIGS. 16 through 19 to identify like components. The primary difference between this latest form of the invention and the earlier described invention resides in the fact that the invention here includes a novel operating assembly 102 that is formed as a single unit and comprises a combination clip assembly and cutting assembly. As before, the apparatus of this latest form of the invention is used in combination with a conventional tape measure “TM” having a housing “H” and a self-recoiling measuring tape “T” extendible from the housing. The elongate measuring tape, which has a slight upward transverse curvature, typically retractably unrolls from a slot in the housing. At its distal end, the tape is provided with a short metal tab “MT” (FIG. 16) that serves the dual functions of preventing the free end of the steel tape from entering the housing of the tape measure through the slot in the housing when retracted and providing the user of the tape measure with a means of conveniently grasping the free end of the tape when manipulating the tape.

The apparatus of this latest form of the invention comprises two major assemblies, namely a tape measure encasement assembly 20 for encasing a portion of the tape measure housing “H” and the previously identified operating assembly 102 that is adapted to be releasably connected to the distal end of the measuring tape. Tape measure encasement assembly 20 is substantially identical in construction and operation to that previously described in connection with the first embodiment of the invention and comprises a base assembly 26, including a platform assembly 28 having a downwardly extending guide segment 28a and an encasement assembly 30 that is connected to platform assembly 28. Forming a part of the platform assembly 28 of the encasement assembly is the important roller wheel assembly 50 of the invention, for measuring the travel of the tape measure encasement relative to the panel “P”.

Referring particularly to FIGS. 16 and 17 of the drawings, the novel operating assembly 102 of the invention, which can be releasably interconnected with the distal end of the measuring tape, can be seen to comprise a hollow housing 104 having a front wall 104a, a top 104b connected to the front wall, a rear wall 104c connected to the top 104b, a pair of spaced apart side walls 104d that are also connected to the top wall and a bottom wall 104e that is connected to the side walls in the manner shown in the drawings. For a purpose presently to be described, top 104b is provided with a top opening 107 (FIG. 17) and each of the side walls 104d is provided with a tape receiving opening 109.

As best seen in FIG. 17 of the drawings, a tape securement assembly 112 is pivotally connected to the side walls 104a of the housing 104 for releasably securing the measuring tape “T” of the tape measure to the hollow housing. The construction and operation of the securement clip assembly will presently be described.

Removably disposed within the top opening 107 of the operating assembly 102 is a cutting instrument such as a conventional, readily commercially available box cutter “BC” (FIGS. 16 and 17). When the cutting instrument is seated within the opening and between the side walls 104d in the manner illustrated in the drawings, the cutting blade “CB” of the cutting instrument extends downwardly from the bottom wall 104e of the operating assembly through a slot 115 (FIG. 17) and into cutting engagement with the panel “P”.

The previously identified tape securement assembly 112 here includes a pair of spaced apart side walls 116 that are pivotally connected to the side walls 104d of the operating assembly in the manner illustrated in FIGS. 16 and 17 of the drawings. Each of the side walls is provided with a tape receiving opening 119 for releasably gripping the tape when the securement assembly is pivoted about pivot pins 120 into the gripping position shown in FIG. 17. In this regard, in operating the apparatus of the invention, the securement assembly is pivoted about the pivot pins from the first retracted position shown in FIG. 16 of the drawings into a second tape gripping position shown in FIG. 17 of the drawings. When the tape securement assembly is in the second gripping position, one side of the tape “T” is positioned within the tape receiving openings 119 and is urged into clamping engagement with the bottom portions of the tape receiving openings formed in side walls 104d of the operating assembly. As illustrated in FIG. 17, a coil spring 122 which is mounted between the front wall 104a and a finger engaging member 124 that is connected to and spans the side walls 104d, continuously urges one side of the tape receiving openings 119 into clamping engagement with the bottom portions of the tape receiving openings 119 (see FIG. 17).

In using the apparatus of the invention with the operating assembly in the configuration shown in FIG. 16 of the drawings and with the housing “H” of the tape measure positioned within the encasement assembly 30, the distal end of the tape is inserted into the openings 109 formed in the sidewalls of the operating assembly. This done, by gripping the finger engaging member 124, the tape securement assembly 112 is rotated from the first position shown in FIG. 16 to the second tape locking position shown in FIG. 17 so as to lockably interconnect the distal end of the tape with the operating assembly.

With the operating assembly 102 connected to the distal end of the tape, the downwardly extending guide segment 28a of the platform assembly 28 can be positioned against the edge of the panel to be cut in the manner illustrated in FIGS. 18 and 19 of the drawings. Next, the tape “T” can be withdrawn from the housing “H” to a distance corresponding to the location at which the panel is to be scored (for example see the dotted line “DL” in FIG. 18). If the workman is right-handed, the operating assembly will be mated with the distal end of the tape in the manner shown in FIG. 18. Conversely, if the workman is left-handed, the operating assembly will be mated with the distal end of the tape in the manner shown in FIG. 19.

With the apparatus in the position illustrated in either FIG. 18 or FIG. 19 of the drawings, the scoring operation can be commenced by simultaneously moving the tape measure encasement assembly 20 and operating assembly 102 longitudinally of the panel. As the tape measure 20 moves longitudinally of the panel, the previously identified roller wheel assembly 50 of the invention will, in the manner previously described, measure the travel of the tape measure encasement relative to the panel.

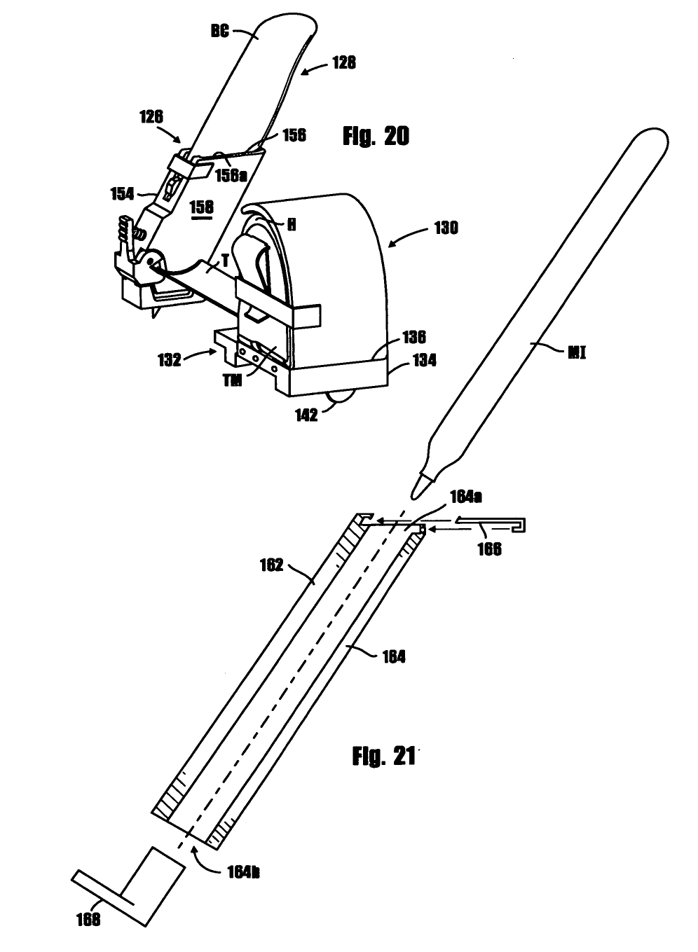

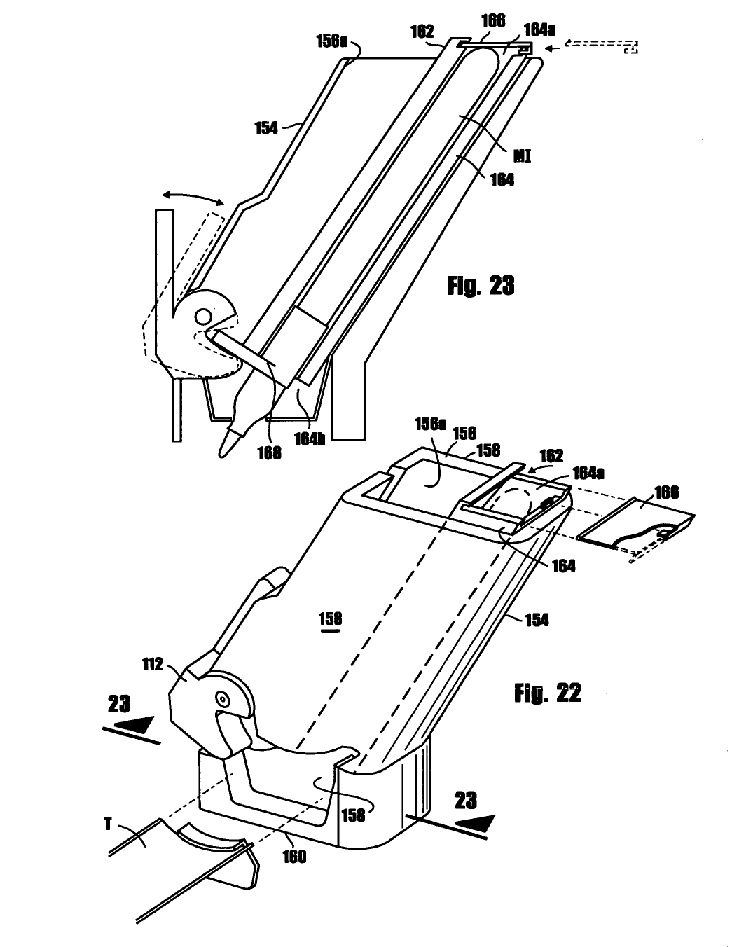

Turning next to FIGS. 20 through 28 and particularly to FIG. 20, yet another form of the apparatus of the invention for measuring, marking and cutting a panel “P” is there shown and generally designated by the numeral 126. This latest form of the apparatus of the invention is similar in some respects to the embodiment of FIGS. 1 through 19 and like numerals are used in FIGS. 20 through 28 to identify like components. The primary differences between this latest form of the invention and the earlier described invention resides in the differently configured operating assembly 128 and the differently configured tape measure encasement assembly 130. As before, the apparatus of this latest form of the invention is used in combination with a conventional tape measure “TM” having a housing “H” and a self-recoiling measuring tape “T” extendible from the housing.

Considering first the differently configured tape measure encasement assembly 130, this novel assembly comprises a base assembly 132, including a base 134 having a top wall 136 for supporting the measuring tape and a pair of spaced apart side walls 138 (see FIGS. 24 through 27). Base 134 also has first and second end portions 134a and 134b and a central portion 134c portion. Additionally, base 134 has a longitudinally extending track 140 that is disposed between side walls 138 (FIG. 24). For a purpose presently to be described, a scoring wheel 142 is connected to and extends downwardly from second end portion 134b (FIGS. 20 and 26).

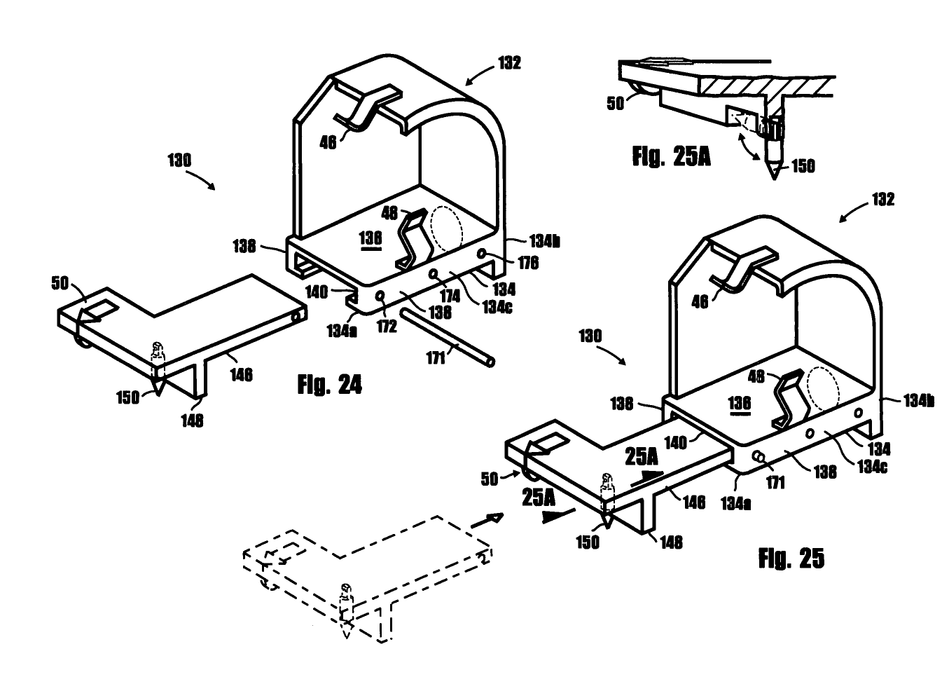

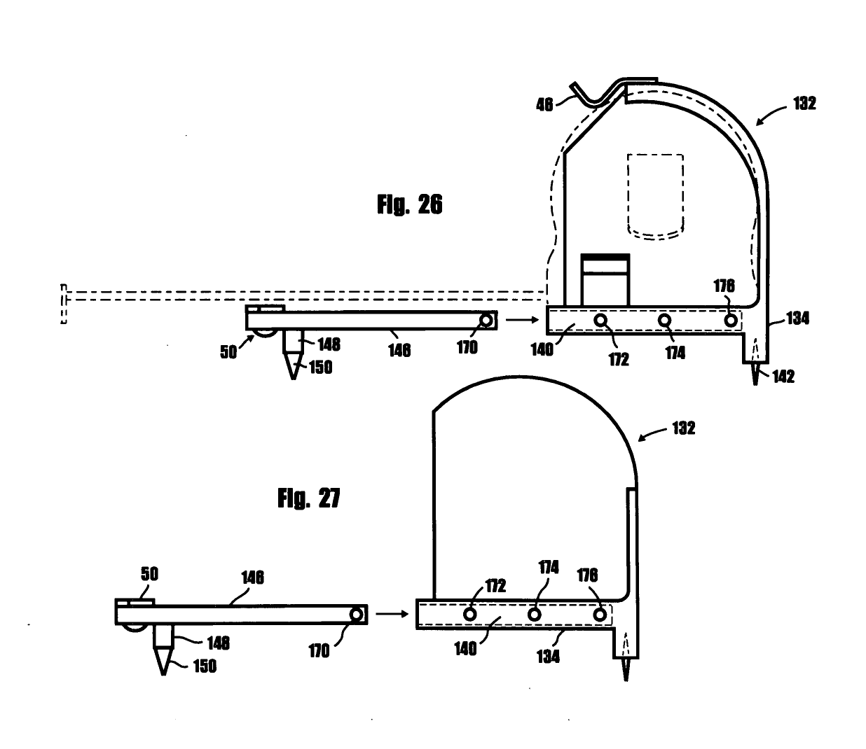

Base assembly 132 further includes a roller wheel assembly support 146 that is receivable within the track 140 of base 134 in the manner shown in FIG. 25. As will later be described, roller wheel assembly support 146 is slidably movable within track 140 for movement between the first position shown in FIG. 25 to a second position and, also, to a third position to enable arcs and circles of different sizes to be scored onto the panel being worked on. Roller wheel assembly support 146 includes a downwardly extending guide segment 148 and a downwardly extending pivot pin 150 that is movable relative to the roller wheel assembly support between a first downwardly extending position shown by the solid lines in FIG. 25A and a second, upwardly folded retracted position shown by the phantom lines in FIG. 25A. The previously discussed roller wheel assembly 50 of the invention for measuring the travel of the tape measure encasement relative to the panel “P” is carried by the roller wheel assembly support 146 in the manner illustrated in FIGS. 24 and 25.

Considering now the operating assembly 128 of this latest form of the invention, this assembly, which can be releasably connected to the distal end of the measuring tape, comprises a hollow housing 154 including a top 156 having a top opening 156a for receiving a box cutter “BC” and a pair of spaced apart side walls 158 that are connected to top 156 (FIG. 22). As before, each of the spaced apart side walls has a tape receiving opening 158 formed therein. The operating assembly 128 also includes a bottom wall 160 that is connected to the side walls and a securement assembly 112 that is connected to the side walls in the manner shown in FIG. 22 of the drawings. Securement assembly 112 is substantially identical in construction and operation to the tape securement assembly 112, previously described in connection with the last described embodiment of the invention.

Receivable within top opening 156a of top 156 is an adapter assembly 162 for mounting therewithin a selected implement, such as the marking implement “MI” shown in FIG. 21. Adapter assembly 162 comprises a sleeve 164 having an open end portion 164a that is closable by a sliding cover 166 and a lower portion 164b that includes a locking tab 168 that is grippable by the securement assembly 112 so as to hold the adapter assembly 162 in position, in the manner depicted in FIG. 23. It is to be understood that various types of implements, including pens, pencils and the like can be mounted within adapter assembly 162.

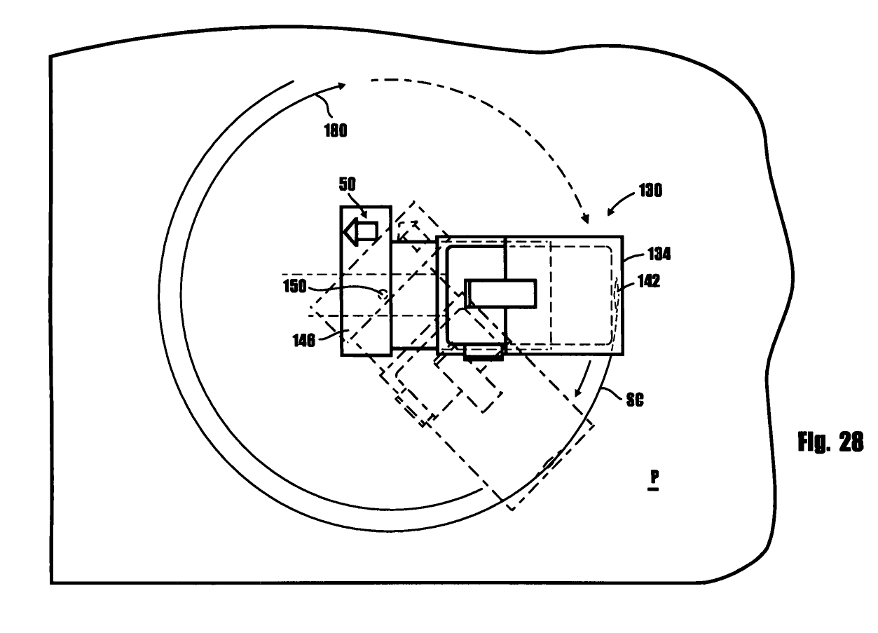

In using the apparatus of this latest form of the invention in the manner illustrated in FIG. 28 to form arcuate scores “SC” and circles of different sizes onto a work piece, the securement assembly 112 is first appropriately manipulated so that the distal end of the tape can be removed from the side walls of the operating assembly. This done, the roller wheel assembly support 146 of the tape measure encasement assembly is moved along the track 140 of base 134 until the locking pin receiving aperture 170 formed in the inboard portion of the roller wheel assembly support 146, which removably receives a locking pin 171, is aligned with a selected one of three locking pin receiving apertures 172, 174 and 176 formed in base 134 (FIGS. 24-27). For example, to produce a score of an intermediate size, the locking pin 171 is removed and the roller wheel assembly support 146 is slidably moved within track 140 between the first position shown in FIG. 25, wherein the locking pin receiving aperture 170 is aligned with locking pin receiving aperture 172 to a second position, wherein the locking pin receiving aperture 170 is aligned with locking pin receiving aperture 174. To produce a score of a larger size, the roller wheel assembly support 146 is slidably moved within track 140 from the second position to a third position wherein the locking pin receiving aperture 170 is aligned with locking pin receiving aperture 176 so that the locking pin 171 can be inserted into apertures 170 and 176. With the locking pin 171 inserted into aperture 170 and into a selected one of three locking pin receiving apertures 172, 174 and 176 formed in base 134, the tape measure encasement assembly 130 is positioned on the panel in the manner illustrated in FIG. 28. Next, in order to score the panel along the arc “SC”, the pivot pin 150 is pressed into the panel and the tape measure encasement assembly 130 is rotated about the pivot pin in the direction of the arrow 180 of FIG. 28 so that the scoring wheel 142 cuts into the surface of the panel.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

1. In combination with a tape measure, an apparatus for measuring, marking and scoring a panel having an upper surface, the tape measure having A housing and a self-recoiling measuring tape extendible from the housing, the measuring tape having a distal end, said apparatus comprising:
(a) a tape measure encasement assembly for encasing a portion of the tape measure housing, said tape measure encasement assembly including a base assembly, having a downwardly extending guide segment;
(b) an operating assembly releasably connected to the distal end of the measuring tape, said operating assembly comprising:
(i) a hollow housing including a top having a top opening, a pair of spaced apart side walls connected to said top, each of said pair of spaced apart side walls having a tape receiving opening formed therein and a bottom wall connected to said pair of spaced apart side walls;
(ii) an implement receivable within said top opening of said top of said hollow housing of said operating assembly; and
(iii) a tape securement assembly connected to said pair of spaced apart side walls of said tape measure housing for releasably connecting the self-recoiling measuring tape to said housing.

2. The apparatus as defined in claim 1 in which said implement receivable within said top opening of said top of said hollow housing of said operating assembly comprises a scoring blade for scoring the panel.

3. The apparatus as defined in claim 1 in which said implement receivable within said top opening of said top of said hollow housing of said operating assembly comprises a marking implement or marking the panel.

4. The apparatus as defined in claim 1 in which said tape measure encasement assembly further includes a roller wheel assembly connected to said base assembly of said tape measure encasement assembly for measuring the travel of said tape measure encasement relative to the panel, said roller wheel assembly comprising a roller wheel constructed and arranged to engage the upper surface of the panel.

5. The apparatus as defined in claim 1 in which said tape measure encasement further includes a sidewall connected to said base assembly, a top wall connected to said side wall, said base, said top wall and said side wall cooperating to define a tape measure housing receiving chamber.

6. The apparatus as defined in claim 1 in which said base assembly of said tape measure encasement comprises:
(a) a base having a track formed therein and including a cutting wheel extending therefrom; and
(b) a roller wheel assembly support receivable within said track of said base for movement between a first and second position, said roller wheel assembly support having a downwardly extending pivot pin.

7. The apparatus as defined in claim 6 in which said pivot pin is movable relative to said roller wheel assembly support between a first downwardly extending position and a second retracted position.

8. In combination with a tape measure, an apparatus for measuring, marking and scoring a panel having an upper surface, the tape measure having housing and a self-recoiling measuring tape extendible from the housing, the measuring tape having a distal end, said apparatus comprising:
(a) a tape measure encasement assembly for encasing a portion of the tape measure housing, said tape measure encasement assembly including a base assembly, having a downwardly extending guide segment and a roller wheel assembly for measuring the travel of said tape measure encasement relative to the panel, said roller wheel assembly comprising a roller wheel constructed and arranged to engage the upper surface of the panel;
(b) an operating assembly releasably connected to the distal end of the measuring tape, said operating assembly comprising:
(i) a hollow housing including a top having a top opening, a pair of spaced apart side walls connected to said top, each of said pair of spaced apart side walls having a tape receiving opening formed therein and a bottom wall connected to said pair of spaced apart side walls;
(ii) an implement receivable within said top opening of said top of said hollow housing of said operating assembly; and
(iii) a tape securement assembly connected to said pair of spaced apart side walls of said tape measure housing for releasably connecting the self-recoiling measuring tape to said housing.

9. The apparatus as defined in claim 8 in which said implement receivable within said top opening of said top of said hollow housing of said operating assembly comprises a scoring blade for scoring the drywall.

10. The apparatus as defined in claim 8 in which said implement receivable within said top opening of said top of said hollow housing of said operating assembly comprises a marking implement for marking the panel.

11. The apparatus as defined in claim 8 in which said base assembly of said tape measure encasement comprises:
(a) a base having a track formed therein and including a cutting wheel extending therefrom; and
(b) a roller wheel assembly support receivable within said track of said base for movement between a first and second position, said roller wheel assembly support having a downwardly extending pivot pin.

12. The apparatus as defined in claim 8 in which said tape securement assembly comprises a pair of spaced apart side walls that are pivotally connected to said side walls of said operating assembly, each of said side walls having a tape receiving opening for releasably gripping the self-recoiling measuring tape.

13. The apparatus as defined in claim 12 in which said tape securement assembly further comprises a finger engaging member connected to and spanning said side walls and a coil spring in engagement with said finger engaging member.

14. In combination with a tape measure, an apparatus for measuring, marking and scoring a panel having an upper surface, the tape measure having a housing and a self-recoiling measuring tape extendible from the housing, the measuring tape having a distal end, said apparatus comprising:
(a) a tape measure encasement assembly for encasing a portion of the tape measure housing, said tape measure encasement assembly including a base assembly, having a downwardly extending guide segment and a roller wheel assembly for measuring the travel of said tape measure encasement relative to the panel, said roller wheel assembly comprising a roller wheel constructed and arranged to engage the upper surface of the panel;
(b) an operating assembly releasably connected to the distal end of the measuring tape, said operating assembly comprising:
(i) a hollow housing including a top having a top opening, a pair of spaced apart side walls connected to said top, each of said pair of spaced apart side walls having a tape receiving opening formed therein and a bottom wall connected to said pair of spaced apart side walls;
(ii) an adapter assembly receivable within said top opening of said top of said hollow housing;
(iii) a marking implement removably receivable within said adapter assembly; and
(iv) a securement assembly connected to said pair of spaced apart side walls of said tape measure housing for releasably gripping said adapter assembly.

15. The apparatus as defined in claim 14 in which said adapter assembly comprises a sleeve having an open end portion and a sliding cover for closing said open end portion of said sleeve.

16. The apparatus as defined in claim 14 in which said base assembly of said tape measure encasement comprises:
(a) a base having a track formed therein and including a scoring wheel extending therefrom; and
(b) a roller wheel assembly support receivable within said track of said base for movement between a first and second position, said roller wheel assembly support having a downwardly extending pivot pin.

17. The apparatus as defined in claim 16 in which said pivot pin is movable relative to said roller wheel assembly support between a first downwardly extending position and a second retracted position.
